(19) United States
(12) Patent Application Publication
(10) Pub. No.: US 2007/0253682 A1
(43) Pub. Date: Nov. 1, 2007

(54) VIDEO RECORDING AND PLAYING SYSTEM AND SIGNAL PICKUP METHOD FOR THE SAME

(75) Inventors: Shih-Ming Chang, Taipei (TW); Meng-Tze Liu, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei Hsien (TW)

(21) Appl. No.: 11/608,621

(22) Filed: Dec. 8, 2006

(30) Foreign Application Priority Data
Apr. 26, 2006 (TW) 095114940

(51) Int. Cl. H04N 5/00

(52) U.S. Cl. 386/125

(57) ABSTRACT

In a signal pickup method for a video recording and playing system, a signal is continuously received and stored in a data buffer of the video recording and playing system. Then, in response to an operation of a control device of the video recording and playing system, a pickup start point and a pickup end point are determined, thereby locating a first data address corresponding to the pickup start point and a second data address corresponding to the pickup end point in the data buffer. Afterward, the data between the first data address and the second data address are saved into a new file.

### FIELD OF THE INVENTION

The present invention relates to a signal pickup method, and more particularly to a signal pickup method for a video recording and playing system.

### BACKGROUND OF THE INVENTION

Nowadays, many electrical appliances are widely used with computers due to the amazing power of computers. For example, the TV signals of cable or wireless TV programs can be transmitted to the personal computer for display. Typically, the TV signals can be transmitted to the personal computer by externally wiring a TV box to the computer or installing a built-in TV tuner card in the computer and then communicating the TV box or built-in TV tuner card with a TV signal input terminal. In such way, the TV programs can be displayed on the personal computer.

Please refer to FIG. 1(a), which is a schematic circuit block diagram illustrating the configuration of displaying TV programs on a conventional computer system. As shown in FIG. 1(a), the TV signals issued from a TV signal input terminal are received by a TV tuner card 14. After channel tuning, encoding/decoding, and signal format conversion are implemented in the TV tuner card 14, the processed signals are transmitted to a host computer 10 via a cardbus 16. Consequently, the TV programs can be displayed on a monitor 11, which is communicated with the host computer 10. In a case that the personal computer is a desktop computer, the TV tuner card complies with the peripheral component interconnect (PCI) specification or the PCI Express (PCIe) specification. Whereas, in another case that the personal computer is a notebook computer, the TV tuner card complies with the cardbus specification.

These TV tuner card devices, i.e. the PCI TV tuner card, the PCIe TV tuner card and the cardbus TV tuner cards, are also referred as TV capture cards. When a TV capture card is applied to the computer system, a memory device such as a hard disc (HD) 101 can be utilized to store related data. In addition, some programs installed in the computer system can be used to edit or process the data. By operating the input device such as a mouse 12 or a keyboard (not shown), the video data corresponding to the TV signals can be displayed on the monitor 11 in real time. Further, these video data can be captured, recorded, and stored in the computer system as video files. By executing an application program associated with the TV tuner card 14 in the host computer 10, a users interface 110 is shown on the monitor 11. As shown in FIG. 1(b), a window 18 and a users interface 110 are shown on the monitor 11 after the application program is executed. By means of the users interface 110 and the mouse 12, the user may control playing or recording operations of the TV signals.

In addition to real-time playing and recording functions, the application program associated with the TV tuner card has some extended functions, for example a time-shift function. By using the time-shift function, the user can move a tracking slider along the position bar 1102 of the users interface 110 to go back while the TV tuner card continuously receives and encodes/decodes the TV signals and performs the signal format conversion. Hence, the user won't miss any scene even through he has to leave for a while. Alternatively, if the user intends to replay a program segment, which has been displayed, the TV program can go back to any position for playback by moving the tracking slider. Meanwhile, the playback operation won't adversely affect the current recording operation.

The principle of implementing the time-shift function will be illustrated as follows. Firstly, when the TV tuner card performs the playing operation, the TV tuner card converts the video signals of the TV program into digital data, and stores the digital data in the hard disc 101 of the host computer 10 as shown in FIG. 1(a). In views of the great storage capacity of the hard disc 101, a data buffer is established in the hard disc 101. For example, upon executing the application program, a data buffer having a predetermined size is defined in the hard disc 101. While the TV program is display, the digital data corresponding to the TV program segments are temporarily stored in the data buffer. That is, the TV program segments corresponding to the newly received TV signals within a predetermined duration are retained in the data buffer. In a case that the time-shift function is activated, the recorded segments can be loaded or displayed as required.

As previously described, the time-shift function allows the user to review the segments stored in the data buffer without affecting the operation of continuously recording the newly received signals into the data buffer in the normal playing state. This time-shift function, however, has some drawbacks when the user intends to record a specific segment of the TV program into a video file. In accordance with a conventional approach, the user can cut the last obtained video file by a video editing program after the TV program is completely recorded to get the program segment video file. Unfortunately, waiting for the completion of the recording operation really wastes much time. In accordance with another conventional approach, the desired segment is recorded as a new file by moving the tracking slider to the start point of the segment to be recorded and then activating the recording function while the TV program is still being recorded. By this approach, the user can simultaneously record the entire TV program and the desired segment. However, for implementing the segment recording, it is necessary to wait till the program segment is completely reproduced and recorded to get the desired segment video file. In other words, a waiting time of recording the program segment is required. Since the above conventional approaches are time-consuming, the applicant keeps on carving unflaggingly to develop a signal pickup method and system according to the present invention through wholehearted experience and research.

### SUMMARY OF THE INVENTION

The present invention provides a signal pickup method for a video recording and playing system to directly convert a segment of a TV program to be captured into a new file without waiting for the completion of the program recording or the segment recording.

In accordance with an aspect of the present invention, there is provided a signal pickup method for a video recording and playing system. In the signal pickup method, a signal is continuously received and stored in a data buffer of the video recording and playing system. Then, in response to an operation of a control device of the video recording and playing system, a pickup start point and a pickup end point are determined, thereby locating a first data address corresponding to the pickup start point and a second data address corresponding to the pickup end point in the data buffer. Afterward, the data between the first data address and the second data address are saved as a new file.

In an embodiment, the video recording and playing system comprises a host computer, a TV module and a monitor. The host computer includes a hard disc. The TV module receives the signal and performs channel tuning, encoding/decoding and signal format conversion. The monitor is used for displaying an image thereon. The data buffer is established in the hard disc. The control device includes a mouse, a keyboard, a remote controller or a touch panel controller, which is electrically connected to the host computer.

In an embodiment, the signal pickup method further comprises steps of executing an application program to provide a users interface including a playing function key and a recording function key on the monitor; activating a time-shift function of the host computer; continuously receiving and processing the signal by the TV module to output corresponding video data, which is stored in the data buffer and displayed on the monitor; implementing a time-shift playback operation by using the mouse to move a tracking slider along a position bar of the users interface; and providing a pickup start index and a pickup end index on the position bar.

In an embodiment, the step of determining the pickup start point and the pickup end point comprises the sub-steps of determining a segment to be captured according to the images shown on the monitor; and using the mouse to drag the pickup start index to the pickup start point corresponding to the start point of the segment, and using the mouse to drag the pickup end index to the pickup end point corresponding to the end point of the segment.

In an embodiment, the step of determining the pickup start point and the pickup end point comprises the sub-steps of determining a segment to be captured according to the time indicator shown on the position bar; and using the mouse to drag the pickup start index to the pickup start point corresponding to the start point of the segment, and using the mouse to drag the pickup end index to the pickup end point corresponding to the end point of the segment.

In an embodiment, the pickup end point is determined by inputting a predetermined recording time after the pickup start point is determined.

In an embodiment, the pickup start index and the pickup end index are stayed at the origin position of the position bar before the pickup start point and the pickup end point are determined, and the pickup end index is located at a later position than the pickup start index.

In an embodiment, the size of the video data stored in the data buffer indicates the earliest position that the tracking slider can be moved to when the time-shift function is activated, and the memory size of the data buffer is determined by the application program.

In an embodiment, the pickup start index and the pickup end index indicate the first data address and the second data address in the data buffer, respectively.

In an embodiment, the signal pickup method further comprises steps of activating the recording function via the users interface when the pickup start index and the pickup end index are respectively dragged to the pickup start point and the pickup end point; and allowing the TV module to pick the data between the first data address and the second data address from the data buffer according to the pickup start index and the pickup end index, and save the data into the file.

In an embodiment, the signal is a TV signal issued from a cable TV signal source or a wireless TV signal source. The signal can be an image signal, an audio signal or a video signal in a digital or an analog format.

In an embodiment, the signal pickup method further comprises a step of converting the signal into a digital form when the signal is in an analog format, and storing the digitalized signal in the data buffer.

In accordance with another aspect of the present invention, there is provided a video recording and playing system for signal pickup. The video recording and playing system comprises a TV module, a host computer, a monitor and a control device. The TV module continuously receives a signal and performs channel tuning, encoding/decoding and signal format conversion on the signal, thereby outputting a processed signal. The host computer is communicated with the TV module and receives the processed signal from the TV module, wherein the host computer has a data buffer for storing the video data corresponding to the signal. The monitor is electrically connected to the host computer for displaying an image corresponding to the signal. The control device is electrically connected to the host computer and operated to determine a pickup start point and a pickup end point. A first data address corresponding to the pickup start point and a second data address corresponding to the pickup end point in the data buffer are located, and the data between the first data address and the second data address are picked and then saved into a file.

### BRIEF DESCRIPTION OF THE DRAWINGS

The above contents of the present invention will become more readily apparent to those ordinarily skilled in the art after reviewing the following detailed description and accompanying drawings, in which:

FIG. 1(a) is a schematic circuit block diagram illustrating the configuration of displaying TV programs on a conventional computer system;

FIG. 1(b) is a schematic view illustrating a window and a users interface shown on the monitor while executing an application program;

FIGS. 2(a)-2(c) schematically illustrate the different states of a position bar of the users interface; and

FIGS. 3(a) and 3(b) illustrates a flowchart of a signal pickup method according to a preferred embodiment of the present invention.

### DETAILED DESCRIPTION OF THE PREFERRED EMBODIMENT

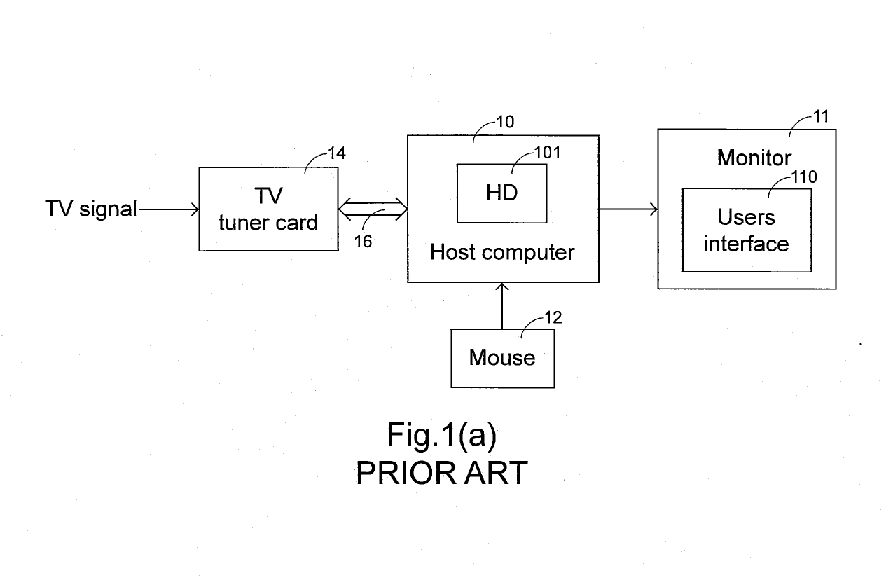

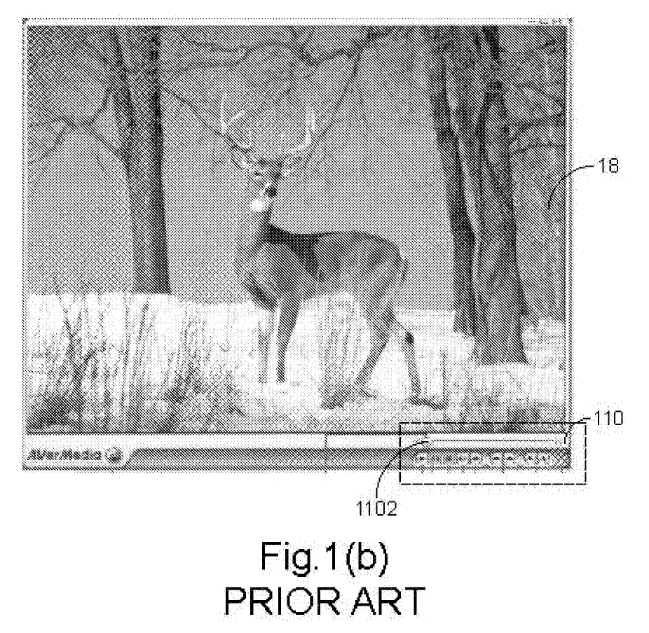

The signal pickup method of the present invention is applicable to the hardware configuration as shown in FIG. 1(a) without additional components. In other words, the signal pickup method is used with a video recording and playing system including a computer system and a TV module. The computer system comprises a host computer 10, a monitor 11 and a mouse 12. The TV module includes a built-in TV tuner card or an external TV box for example. In this embodiment, the TV tuner card 14 is taken as the TV module to explain the present invention. The TV tuner card 14 is used to implement several operations including channel tuning, encoding/decoding, and signal format conversion. In accordance with a major feature of the present invention, a software program and an application program associated with the TV tuner card 14 and installed in the computer are modified, and the signal conversion and pickup tasks for the TV programs are improved by executing these programs. In this embodiment, the hardware of the video recording and playing system is substantially unchanged, and is not redundantly described herein. The TV signals as shown in FIG. 1(a) are issued from a cable TV signal source or a wireless TV signal source and include image, audio or video signals in a digital or an analog format. In this embodiment, analog TV signals are used to describe the present invention.

As previously described, the video recording and playing system comprises a host computer 10, a monitor 11, a mouse 12 and a TV tuner card 14. In a case that the real-time playing operation or the recording operation is activated, the TV signals are successively transmitted to the TV tuner card 14. The TV signals are processed by the TV tuner card 14 to output corresponding video data. The processed TV signals are temporarily stored in a data buffer (not shown), which is established in the hard disc 101 of the host computer 10. In this embodiment, the analog TV signals should be converted into digital TV signals so that the digitalized video data can be temporarily stored in the data buffer.

In accordance with the present invention, the memory size of the data buffer is determined when the application program is executed. For example, the data buffer can be defined to store therein the video data having predetermined time length of half an hour, one hour or others according to the capacity limit of the hard disc 101 and the user's preference. Likewise, the TV tuner cards 14 can support the playing, recording and time-shift functions for the TV signals. Since the video data corresponding to the TV signals are stored in the data buffer and simultaneously displayed on the monitor 12, the size of the video data stored in the data buffer relates to the earliest position that the program can go back in the time-shift mode.

Please refer to FIG. 1(b) again. A window 18 and a users interface 110 are shown on the monitor 11 when the application program is executed. By selecting desired function keys shown on the users interface 110, the TV program will be displayed in the window 18 or further processed. In this embodiment, the desired function keys are selected by means of a mouse 12. Nevertheless, other input device such as a keyboard, a remote controller or a touch panel controller can be used to select the desired function keys. In addition, the position bar 1102 of the users interface 110 indicates the time status of the live TV program.

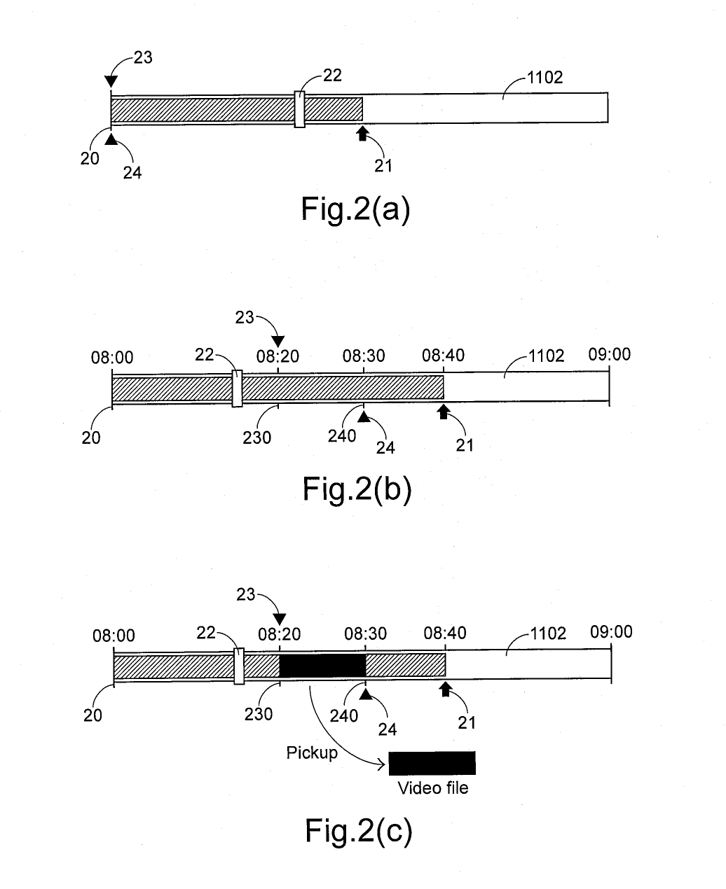

Please refer to FIG. 2(a), which schematically illustrates the appearance of the position bar 1102 when the TV tuner card 14 is operated in the time-shift mode. The time length shown on the position bar 1102 means the allowable size of the video data stored in the data buffer. A storage index 21 shown under the position bar 1102 indicates the current size of the video data stored in the data buffer, i.e. the current recording position. In other words, if the storage index 21 moves to the right margin of the position bar 1102 during the playing or recording operation, the video data stored in the data buffer reach the allowable size, one hour of video data for example. Under this circumstance, the video data corresponding to the newly received TV signals will replace the earliest recorded video data in the data buffer so that the video data stored in the data buffer won't excess one-hour restriction during the playing or recording operation. Consequently, when the time-shift function is activated and a live TV program is displayed, the user may move a tracking slider 22 along the position bar 1102 to replay the previous program segments.

In accordance with other features of the present invention, a pickup start index 23 and a pickup end index 24 are provided on the position bar 1102. By using the mouse 12 to drag the pickup start index 23 and the pickup end index 24 along the position bar 1102, the pickup start index 23 and the pickup end index 24 will be stayed at desired positions on the position bar 1102 to indicate the recording start position and the recording end position. By dragging the pickup start index 23 and the pickup end index 24 to the desired positions on the position bar 1102, a segment of a TV program can be captured or saved as a new file while the TV program is kept being displayed or recorded due to time-shift support.

Please refer to FIGS. 2(b) and 2(c), which schematically illustrate the pickup start index 23 and the pickup end index 24 stayed at desired positions on the position bar 1102.

As shown in FIG. 2(b), the pickup start index 23 and the pickup end index 24 are both stayed at the origin position 20 of the position bar 1102, for example at 08:00 when the playing or recording function is activated. The storage index 21 stays at the current playing or recording position, for example 8:40. In a case that the data buffer for storing the video data therein has a capacity corresponding to one hour of video data, the segments of the TV program from 08:00 to 08:40 are retained in the data buffer. By moving the tracking slider 22 along the position bar 1102 and viewing the images shown in the window 18, the pickup start point and the pickup end point for capturing the segment of the TV program are determined. For example, as also shown in FIG. 2(b), the segment to be captured starts at the pickup start point 230 (e.g. 08:20) and ends at the pickup end point 240 (e.g. 08:30). By using the mouse 12 to drag the pickup start index 23 and the pickup end index 24 to the pickup start point 230 and the pickup end point 240, respectively, the program segment from 08:20 to 08:30 will be captured. Accordingly, the data addresses in the data buffer corresponding to the pickup start point 230 and the pickup end point 240 are determined.

Then, as shown in FIG. 2(c), when the recording function is activated by clicking the recording function key for example, the video data stored between the data address corresponding to the pickup start point 230 and the data address corresponding to the pickup end point 240, i.e. the black region, are picked and saved as a new file stored in the hard disc 101. Consequently, by using the signal pickup method of the present invention, the video file corresponding to the segment to be captured can be instantly obtained without the time-consuming recording or playing step.

By the way, the pickup end point 240 should be placed at a later position than the pickup start point 230 because the segment to be captured is determined by the region defined by the pickup start index 23 and the pickup end index 24. Hence, the pickup end index 24 cannot be moved to the left of the pickup start index 23.

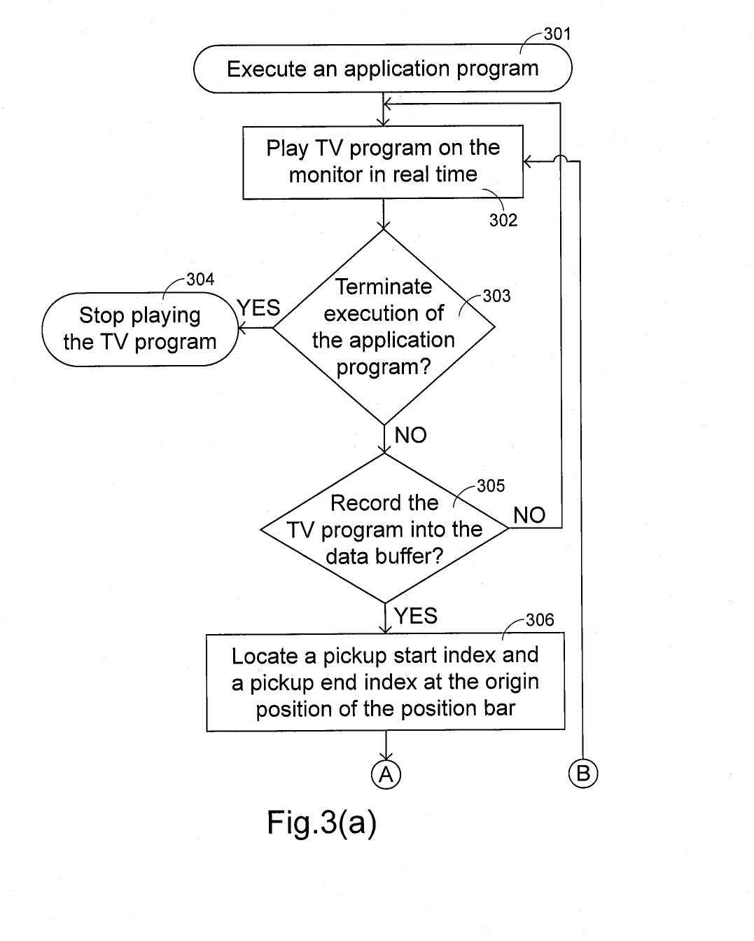

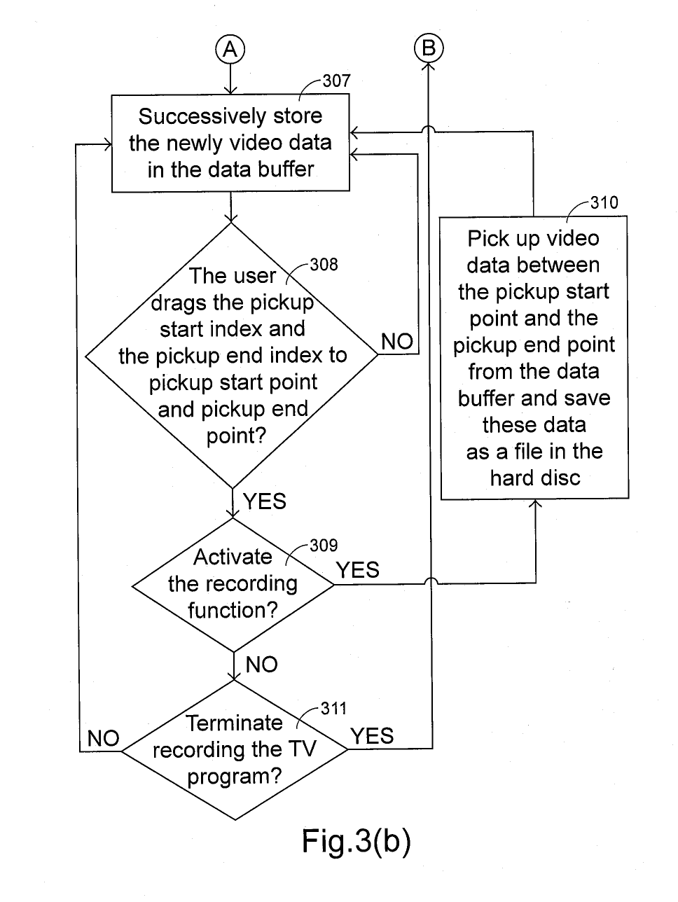

Hereinafter, a flowchart of a signal pickup method for a video recording and playing system according to a preferred embodiment of the present invention will be illustrated with reference to FIGS. 3(a) and 3(b).

First of all, by executing an application program associated with the TV tuner card (Step 301), a TV program resulting from the TV signals are displayed on the monitor 11 for real-time play (Step 302). If the execution of the application program is terminated (Step 303), the application program stop playing the TV program (Step 304). Otherwise, if the user intends to record a segment of the TV program (Step 305), the pickup start index 23 and the pickup end index 24 are automatically positioned at the origin position 20 of the position bar 1102 (Step 306) and the newly received video data of the TV signals are successively stored in the data buffer (Step 307). Subsequently, if the pickup start index 23 and the pickup end index 24 are dragged to the pickup start point 230 and the pickup end point 240 by the user (Step 308), then the user can activate the recording function (Step 309). If the recording function is activated, the video data between the data addresses corresponding to the pickup start point 230 and the pickup end point 240 are picked and saved as another video file in the hard disc 101 (Step 310). Otherwise, the user can terminate recording the TV program (Step 311).

In the above embodiment, the images shown in the window 18 facilitate the user to locate the pickup start index 23 and the pickup end index 24 at the precise positions. Alternatively, if the pickup start point and the pickup end point have been known in advance, according to the time indicator shown above (or under) the position bar 1102, the steps of dragging the tracking slider 22 to a certain position of the position bar 1102 and viewing the images shown in the window 18 can be omitted. In addition, the pickup start point 230 may be determined after a portion of the TV program has been viewed in the time-shift mode. Under this circumstance, the pickup end point 240 is determined by inputting a predetermined recording time in a pop-up dialogue box (not shown) displayed on the monitor 11 when the application program is executed. For example, the user can set the pickup start point 230 at 8:20 and input 10 minutes in the pop-up dialogue box to indicate that the pickup end point 240 should be positioned at 8:30 without dragging the pickup end index 24. It is noted that, however, those skilled in the art will readily observe that numerous modifications and alterations of determining the pickup start point 230 and the pickup end point 240 may be made while retaining the teachings of the invention. Accordingly, the above disclosure should be limited only by the scope of the following claims.

From the above description, by using the signal pickup method of the present invention, the segment to be captured can be rapidly picked and saved as a file without waiting for the completion of the segment recording operation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A signal pickup method for a video recording and playing system, the signal pickup method comprising steps of:
continuously receiving a signal and storing the signal in a data buffer of the video recording and playing system;
determining a pickup start point and a pickup end point in response to an operation of a control device of the video recording and playing system, thereby locating a first data address corresponding to the pickup start point and a second data address corresponding to the pickup end point in the data buffer; and
saving the data between the first data address and the second data address into a file.

2. The signal pickup method according to claim 1 wherein the video recording and playing system comprises:
a host computer including a hard disc;
a TV module receiving the signal and performing channel tuning, encoding/decoding, and signal format conversion; and
a monitor for displaying an image corresponding to the signal,
wherein the data buffer is established in the hard disc and the control device is one selected from a mouse, a keyboard, a remote controller and a touch panel controller, which is electrically connected to the host computer.

3. The signal pickup method according to claim 2 further comprising steps of:
executing an application program to provide a users interface including a playing function key and a recording function key on the monitor;
activating a time-shift function of the host computer;
continuously receiving and processing the signal by the TV module to output corresponding video data, which is stored in the data buffer and displayed on the monitor;
implementing a time-shift playback operation by using the mouse to move a tracking slider along a position bar of the users interface; and
providing a pickup start index and a pickup end index on the position bar.

4. The signal pickup method according to claim 3 wherein the step of determining the pickup start point and the pickup end point comprises the sub-steps of:
determining a segment to be captured according to the images shown on the monitor; and
using the mouse to drag the pickup start index to the pickup start point corresponding to the start point of the segment, and using the mouse to drag the pickup end index to the pickup end point corresponding to the end point of the segment.

5. The signal pickup method according to claim 3 wherein the step of determining the pickup start point and the pickup end point comprises the sub-steps of:
determining a segment to be captured according to the time indicator shown on the position bar; and
using the mouse to drag the pickup start index to the pickup start point corresponding to the start point of the segment, and using the mouse to drag the pickup end index to the pickup end point corresponding to the end point of the segment.

6. The signal pickup method according to claim 3 wherein the pickup end point is determined by inputting a predetermined recording time after the pickup start point is determined.

7. The signal pickup method according to claim 3 wherein the pickup start index and the pickup end index are stayed at the origin position of the position bar before the pickup start point and the pickup end point are determined, and the pickup end index is located at a later position than the pickup start index.

8. The signal pickup method according to claim 3 wherein the size of the video data stored in the data buffer indicates the earliest position that the tracking slider can be moved to when the time-shift function is activated, and the memory size of the data buffer is determined by the application program.

9. The signal pickup method according to claim 3 wherein the pickup start index and the pickup end index indicate the first data address and the second data address in the data buffer, respectively.

10. The signal pickup method according to claim 3 further comprising steps of:
activating the recording function via the users interface when the pickup start index and the pickup end index are respectively dragged to the pickup start point and the pickup end point; and
allowing the TV module to pick the data between the first data address and the second data address from the data buffer according to the pickup start index and the pickup end index, and save the data into the file.

11. The signal pickup method according to claim 1 wherein the signal is a TV signal issued from one of a cable TV signal source and a wireless TV signal source, and the signal is one selected from the group consisting an image signal, an audio signal and a video signal in a digital or an analog format.

12. The signal pickup method according to claim 11, further comprising a step of converting the signal into a digital form when the signal is in an analog format, and storing the digitalized signal into the data buffer.

13. A video recording and playing system for signal pickup, comprising:
a TV module continuously receiving a signal and performing channel tuning, encoding/decoding and signal format conversion on the signal, thereby outputting a processed signal;
a host computer communicated with said TV module and receiving the processed signal from said TV module, wherein said host computer has a data buffer for storing data corresponding to the signal;
a monitor electrically connected to said host computer for displaying an image corresponding to the signal; and
a control device electrically connected to said host computer and operated to determine a pickup start point and a pickup end point, wherein a first data address corresponding to the pickup start point and a second data address corresponding to the pickup end point in said data buffer are located, and the data between the first data address and the second data address in said data buffer are picked and saved into a file.

14. The video recording and playing system according to claim 13 wherein the signal is a TV signal issued from one of a cable TV signal source and a wireless TV signal source, and the signal is one selected from a group consisting of an image signal, an audio signal and a video signal in a digital or analog format, wherein said TV module converts the signal into a digital form when the signal is in an analog format, and then stores the digitalized signal in said data buffer.

15. The video recording and playing system according to claim 13 wherein said host computer further comprises a hard disk, said data buffer is established in said hard disc, and said host computer further comprises an application program executed to define said data buffer in said hard disc.

16. The video recording and playing system according to claim 15 wherein said control device is one selected from a group consisting a mouse, a keyboard, a remote controller and a touch panel controller, which is electrically connected to said host computer.

17. The video recording and playing system according to claim 16 wherein a users interface including a playback function key and a recording function key is provided and shown on said monitor by executing the application program, and a time-shift function is activated by moving a tracking slider along a position bar of the users interface.

18. The video recording and playing system according to claim 17 wherein a pickup start index and a pickup end index are stayed at the origin position of the position bar, and when a segment is to be captured, the pickup start index and the pickup end index are respectively dragged to the pickup start point corresponding to a start point of the segment and the pickup end point corresponding to an end point of the segment, and the pickup end index is located at a later position than the pickup start index.

19. The video recording and playing system according to claim 18 wherein the positions of the pickup start point and the pickup end point are determined according to the image shown on said monitor or the time indicator shown on the position bar.

20. The video recording and playing system according to claim 18 wherein the pickup start index and the pickup end index indicate the first data address and the second data address in said data buffer, respectively, and in response to activation of the recording function, said TV module picks the data between the first data address and the second data address from the data buffer according to the pickup start index and the pickup end index, thereby saving the data into the file.
